(19) United States
(12) Patent Application Publication
(10) Pub. No.: US 2010/0120576 A1
(43) Pub. Date: May 13, 2010

(54) PLANETARY GEAR DEVICE

(76) Inventors: Masanori Satou, Shizuoka (JP); Takanori Terada, Shizuoka (JP)

Correspondence Address: WENDEROTH, LIND & PONACK, L.L.P., 1030 15th Street, N.W.,, Suite 400 East, Washington, DC, 20005-1503, US

(21) Appl. No.: 12/593,395

(22) PCT Filed: Feb. 13, 2008
(86) PCT No.: PCT/JP2008/052300

§ 371 Date: Sep. 28, 2009

(30) Foreign Application Priority Data
Mar. 29, 2007 (JP) 2007-088955
Mar. 29, 2007 (JP) 2007-088972

(51) Int. Cl. F16H 57/08

(52) U.S. Cl. 475/348

(57) ABSTRACT

The present invention provides a planetary gear device that can prevent wear and seizing of a pinion gear and a carrier, has few components, and of which assembly is not complicated. In the planetary gear device of the invention, a pinion gear 14 is supported such as to rotate freely by an outer circumferential surface of a pinion shaft 13 with a needle roller 15 interposed therebetween. The pinion shaft 13 is fixed between a pair of carriers 11 and 11. A hard coating including a diamond-like carbon is formed on surfaces of the carriers 11 and 11 facing both end surfaces of the pinion gear 14 and the needle roller 15. Wear and seizing can be prevented as a result of the hard coating even when the end surfaces of the pinion gear 14 and the needle roller 15 come into sliding contact with the surfaces of the carriers 11 and 11 during operation of the planetary gear device. Because the number of washers 16 can be reduced, the number of components can be reduced and complicated assembly can be reduced.

### TECHNICAL FIELD

The present invention relates to a planetary gear device used in a power transmission device of automobiles and various industrial machineries.

### BACKGROUND ART

For example, a planetary gear device is used in a power transmission device of an automobile. In the planetary gear device, a pinion shaft is fixed to a carrier that is supported such as to rotate freely. A pinion gear is attached to the pinion shaft such as to rotate freely. Conventionally, various configurations related to pinion gears and carriers have been proposed to prevent wear and seizing.

In Patent Document 1, a planetary gear device is described in which a pinion gear is supported by a pinion shaft with a needle roller therebetween. The pinion shaft connects a pair of carriers. Two washers each are interposed between both end surfaces of the pinion gear and the needle roller, and the carriers.

In Patent Document 2 and Patent Document 3, a Ravigneaux-type planetary gear device is described that is a combination of a single pinion planetary gear set and a double pinion planetary gear set. In each planetary gear set, a pinion gear is supported by a pinion shaft with a roller bearing therebetween. A washer is interposed between the end surfaces of the pinion gear and the roller bearing, and an adjacent surface of a carrier.

Patent Document 1: Japanese Utility Model Laid-open Publication No. Heisei 7-19660

### Patent Document 2: Japanese Patent No. 3867651

### Patent Document 3: Japanese Patent Laid-open Publication No. 2004-124977

### DISCLOSURE OF THE INVENTION

### Problems to be Solved by the Invention

However, in all of the above-described conventional planetary gear devices, a problem is present in that, because a washer is interposed between the end surfaces of the pinion gear and the bearing, and the carrier, the number of components is large and assembly is complicated. The number of components is large and assembly is complicated particularly in the planetary gear device in Patent Document 1, because two washers each are interposed between both end surfaces of the pinion gear and the needle roller, and the carriers.

In the planetary gear devices in Patent Document 2 and Patent Document 3, a single washer is interposed between the end surfaces of the pinion gear and the roller bearing, and the adjacent surface of the carrier. Therefore, when thrust load is applied to the pinion gear and the carrier, a problem is present in that wear and seizing caused by sliding contact easily occur.

Therefore, an object of the present invention is to provide a planetary gear device that can prevent wear and seizing of a pinion gear and a carrier, has few components, and of which assembly is not complicated.

### Means for Solving the Problems

To solve the above-described issues, in a planetary gear device according to a first aspect of the invention, a pinion gear is supported such as to rotate freely by a pinion shaft fixed to a carrier. In the planetary gear device, the carrier has a hard coating on a surface on the pinion gear side. The carrier and the pinion gear are adjacent to each other without a component interposed therebetween.

As a result of the configuration, wear and seizing can be prevented by the hard coating provided on the carrier, even when adjacent carrier and pinion gear come into contact with each other during operation of the planetary gear device. Because a washer conventionally interposed between the carrier and the pinion gear can be eliminated, the number of components can be reduced and complicated assembly can be reduced.

A planetary gear device according to a second aspect is the planetary gear device according to the first aspect, in which the pinion gear is supported such as to rotate freely via a needle roller disposed on an outer circumferential surface of the pinion shaft. An end surface of the needle roller faces the hard coating on the carrier.

According to the second aspect, wear and seizing of the needle roller and the carrier can be prevented by the hard coating formed on the carrier, even when the end surface of the needle roller comes into contact with the carrier during operation of the planetary gear device.

A planetary gear device according to a third aspect is the planetary gear device according to the first or second aspect, in which the hard coating has a hardness of Hv1000 or more.

According to the third aspect, because the hardness (Vickers hardness; the same applies hereinafter) of the hard coating is Hv1000 or more, wear and seizing can be effectively prevented even when the pinion gear and the like come into contact with the carrier.

A planetary gear device according to a fourth aspect is the planetary gear device according to any one of the first to third aspects, in which the hard coating includes a diamond-like carbon.

According to the fourth aspect, the hardness of Hv1000 or more can be achieved by the hard coating including the diamond-like carbon (DLC). In addition, friction coefficient can be reduced to, for example, about 0.1. Therefore, wear and seizing can be very effectively prevented even when the pinion gear and the like come into contact with the carrier.

A planetary gear device according to a fifth aspect is the planetary gear device according to any one of the first to third aspects, in which the hard coating includes chrome nitride.

According to the fifth aspect, the hardness of Hv1000 or more can be achieved by the hard coating including chrome nitride (CrN). Therefore, wear and seizing can be effectively prevented even when the pinion gear and the like come into contact with the carrier.

A planetary gear device according to a sixth aspect is a planetary gear device in which a pinion gear is supported such as to rotate freely by a pinion shaft fixed to a carrier, and a washer is interposed between the pinion gear and the carrier. A surface of the washer has a hard coating. The washer is a single washer disposed between an end surface of the pinion gear and a surface of the carrier.

As a result of the configuration, wear and seizing can be prevented even when adjacent carrier and pinion gear come into contact with each other during operation of the planetary gear device, because the surface of the washer has the hard coating. Only a single washer is interposed between the end surface of the pinion gear and the surface of the carrier. Therefore, compared to when two washers are interposed, the number of components can be reduced and complicated assembly can be reduced.

A planetary gear device according to a seventh aspect is the planetary gear device according to the sixth aspect, in which the surface of the washer has a recess.

According to the seventh aspect, lubricating oil is held in the recess on the surface of the washer. Therefore, wear and seizing between the pinion gear and the carrier can be effectively prevented even when only a single washer is interposed between the pinion gear and the carrier.

A planetary gear device according to an eighth aspect is the planetary gear device according to the seventh aspect, in which the recess in the washer is a plurality of circular grooves concentric with a center of the washer.

According to the eighth aspect, the lubricating oil can be spread in a circumferential direction over the end surface of the pinion gear and the surface of the carrier by the plurality of circular grooves. The lubricating oil can be effectively held within the circular grooves extending in the circumferential direction, even when centrifugal force accompanying rotation of the washer around the pinion shaft and rotation of the carrier is applied.

A planetary gear device according to a ninth aspect is the planetary gear device according to the seventh aspect, in which the recess in the washer is a plurality of linear grooves extending in a radial direction of the washer.

According to the ninth aspect, the lubricating oil can be supplied from a pinion shaft side to an outer peripheral side of the pinion gear via the plurality of linear grooves.

A planetary gear device according to a tenth aspect is the planetary gear device according to the seventh aspect, in which the recess in the washer is a plurality of bottomed holes discretely provided on the surface of the washer.

According to the tenth aspect, the lubricating oil can be evenly held over the surface of the washer within the plurality of discretely provided bottomed holes. Therefore, wear and seizing of the washer contact surfaces of the pinion gear and the carrier can be stably prevented.

A planetary gear device according to an eleventh aspect is the planetary gear device according to any one of the sixth to tenth aspects, in which the pinion gear is held such as to rotate freely via a needle roller disposed on an outer circumferential surface of the pinion shaft. Each end surface of the pinion gear and the needle roller faces the surface of the washer.

According to the eleventh aspect, wear and seizing of the needle roller can be prevented by the hard coating formed on the washer, even when the end surface of the needle roller comes into contact with the washer during operation of the planetary gear device.

A planetary gear device according to a twelfth aspect is the planetary gear device according to any one of the sixth to eleventh aspects, in which the hard coating has a hardness of Hv1000 or more.

According to the twelfth aspect, because the hardness of the hard coating is Hv1000 or more, wear and seizing on the contact surfaces between the pinion gear and the carrier, and the washer can be effectively prevented.

A planetary gear device according to a thirteenth aspect is the planetary gear device according to any one of the sixth to twelfth aspects, in which the hard coating includes a diamond-like carbon.

According to the thirteenth aspect, the hardness of Hv1000 or more can be achieved by the hard coating including the DLC. In addition, the friction coefficient can be reduced to, for example, about 0.1. Therefore, wear and seizing on the contact surfaces between the pinion gear and the carrier, and the washer can be very effectively prevented.

A planetary gear device according to a fourteenth aspect is the planetary gear device according to any one of the sixth to twelfth aspects, in which the hard coating includes chrome nitride.

According to the fourteenth aspect, the hardness of Hv1000 or more can be achieved by the hard coating including CrN. Therefore, wear and seizing on the contact surfaces between the pinion gear and the carrier, and the washer can be effectively prevented.

### ADVANTAGE OF THE INVENTION

In the planetary gear device of the present invention, the hard coating is formed on the carrier on the surface on the pinion gear side. Therefore, wear and seizing can be prevented even when the carrier and the pinion gear come into contact with each other. As a result, a washer conventionally interposed between the carrier and the pinion gear can be eliminated. The number of components can be reduced and complex assembly can be reduced.

In addition, when a washer is interposed between the pinion gear and the carrier, wear and seizing on the contact surfaces of adjacent carrier and pinion gear can be prevented because the surface of the washer has a hard coating. Because only a single washer is disposed between the end surface of the pinion gear and the surface of the carrier, the number of components can be reduced and complex assembly can be reduced.

### BRIEF DESCRIPTION OF THE DRAWINGS

FIG. 1a is a partial cross-sectional view of a planetary gear device according to a first embodiment of the present invention;

FIG. 1b is a partial cross-sectional view of a planetary gear device according to a second embodiment of the present invention;

FIG. 2a is a diagram of a surface of washer having circular grooves;

FIG. 2b is a diagram of a surface of a washer having linear grooves; and

FIG. 2c is a diagram of a surface of a washer having discretely formed bottomed holes.

### BEST MODE FOR CARRYING OUT THE INVENTION

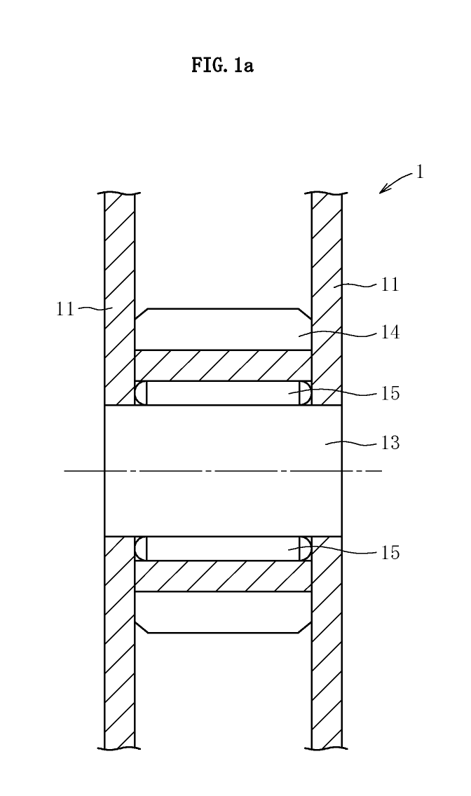

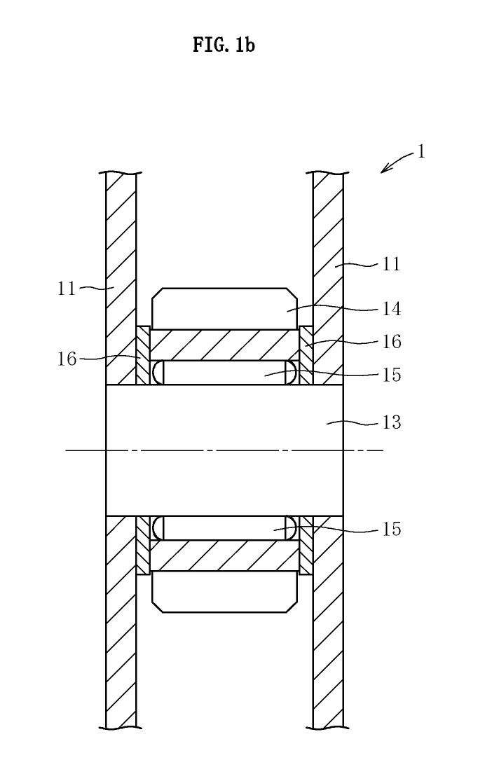

Embodiments of the present invention will be described below with reference to the drawings. FIG. 1a is a schematic cross-sectional view of a portion of a planetary gear device according to an embodiment of the present invention.

A planetary gear device 1 is, for example, used in a transmission of an automobile. A pair of carriers 11 and 11 are supported such as to rotate freely by a rotating shaft. The rotating shaft is coaxial with a sun gear (not shown). A pinion gear 14 is supported such as to rotate freely by a pinion shaft 13. The pinion shaft 13 is fixed between the carriers 11 and 11. A plurality of pinion gears 14 are disposed in a circumferential direction of the carriers 11 and 11, with the rotating shaft of the carriers 11 and 11 serving as a center. Each pinion gear 14 meshes with the sun gear. The plurality of pinion gears 14 are surrounded by an outer gear (not shown) and mesh with teeth formed on an inner circumferential surface of the outer gear. The outer gear is supported coaxially with the sun gear and the carriers 11 and 11, such as to rotate freely.

The pinion gear 14 is supported on the outer circumference of the pinion shaft 13 such as to rotate freely, with a plurality of needle rollers 15 therebetween. The needle rollers 15 are disposed in a full-complement state. Both end surfaces of the needle roller 15 is formed into spherical surfaces. On the opposing surfaces of the pair carriers 11 and 11, a diamond-like carbon (DLC) coating is formed as a hard coating. The DLC coating has a hardness of Hv1000 or more and a friction coefficient of about 0.1.

The DLC coating is an amorphous material, primarily composed of carbon element. For example, the DLC coating can be formed by amorphous carbon (a-C) composed only of carbon element, hydrogenated amorphous carbon (a-C:H) that includes hydrogen, or metal carbon or metal carbide (MeC) that partially includes a metal element such as titanium (Ti) or molybdenum (Mo). In terms of enhancing friction reduction effect, however, a material having low hydrogen content is preferable. Specifically, a material having a hydrogen content of 10.0 atomic % or less is preferable. A material having a hydrogen content of 1.0 atomic % is more preferable. An amorphous carbon type (a-C type) material that does not include hydrogen is even more preferable. Taking into consideration spreading of lubricating oil, the a-C type material that does not include hydrogen is preferable. The DLC coating is preferably 0.1 μm to 1 μm thick. The DLC coating can be formed by physical vapor deposition (PVD) or chemical vapor deposition (CVP).

Both end surfaces of the pinion gears 14 and both end surfaces of the needle rollers 15 are adjacent to the surfaces of the carriers 11 and 11 on which the DLC coating is formed.

Lubricating oil is supplied to sliding sections of the carriers 11, the pinion gears 14, and the pinion shaft 13. For example, automatic transmission fluid (ATF) can be used as the lubricating oil. The lubricating oil can be supplied via an oil path formed within the pinion shaft 13.

Each gear in the planetary gear device 1 of the embodiment is constantly meshed with each other. As a result of driving force being applied to any element among three elements that are the sun gear, the carriers 11 and 11, and the outer gear, and any of the three elements being locked, driving force that is decelerated to a predetermined speed reduction ratio is outputted from the remaining element. As a result of assignment of the roles of being fixed, receiving the driving force, and outputting the driving force being changed among the three elements, switching can be performed between a plurality of speed reduction ratios and rotation directions.

When the planetary gear device 1 is operating, in accompaniment with the rotation of the pinion gear 14, the end surfaces of the pinion gear 14 and the surfaces of the carriers 11 and 11 come into sliding contact. In addition, the end surfaces of the needle roller 15 supporting the pinion gear 14 and the surfaces of the carriers 11 and 11 come into sliding contact. When thrust load is applied to the pinion gear 14, the surface pressure between the pinion gear 14 and the needle roller 15, and the carriers 11 and 11 increase. Here, the DLC coating having a high hardness and a low friction coefficient is formed on the surfaces of the carriers 11 and 11 that come into contact with the end surfaces of the pinion gear 14 and the end surfaces of the needle roller 15. Therefore, wear and seizing that accompany sliding contact can be effectively prevented, even when a washer conventionally provided between the pinion gear and the carriers is not provided. As a result, the number of components in the planetary gear device 1 can be reduced and complicated assembly can be reduced.

In addition, because the end surfaces of the needle roller 15 that comes into contact with the carriers 11 and 11 are formed into spherical surfaces, seizing can be effectively prevented. As a result of the end surfaces of the needle roller 15 being formed into spherical surfaces, the surface pressure at the contact surfaces between the needle roller 15 and the carriers 11 and 11 is large. However, the DLC coating on the surfaces of the carriers 11 and 11 effectively prevent wear.

An embodiment of the present invention is described above. However, the present invention is not limited to the embodiment. Various modifications can be made. For example, although the DLC coating is used as the hard coating on the carriers 11 and 11 according to the embodiment, the hard coating can be formed by chrome nitride (CrN).

In addition, the hard coating can be configured by an intermediate layer being interposed between the main component and the outermost layer composed of the DLC coating.

The hard coating formation area is not required to be the overall surfaces of the carriers 11 and 11. The hard coating can be formed only in the portions coming into contact with the pinion gears 14 and the needle rollers 15.

Although the pinion gear 14 is supported such as to rotate freely by the needle roller 15 that is in a full-complement state, the pinion gear 14 can be supported through use of another type of bearing device. For example, both end surfaces of the needle roller can be flat. A needle roller with a cage can also be used. An inner member can be fixed to the pinion shaft 13, while an outer member is fixed to the pinion gear 14. A rolling member can be interposed between the inner member and the outer member, allowing the pinion gear 14 to be supported to rotate freely. In this instance, the hard coating is formed on the surfaces of the carriers 11 and 11 adjacent to the end surfaces of the outer member.

FIG. 1b is a schematic cross-sectional view of a portion of a planetary gear device according to a second embodiment of the present invention. The planetary gear device 1 is, for example, used in a transmission of an automobile. Sections that are the same as those in FIG. 1a are given the same reference numbers.

A single washer 16 is interposed between each end surface of the pinion gear 14 and the surfaces of the carriers 11 and 11. The washer 16 is made of a steel plate. A DLC coating serving as a hard coating that is the same as that described according to the embodiment in FIG. 1a is formed on the surface of the washer 16. The DLC coating has a hardness of Hv1000 or more and a friction coefficient of about 0.1. The washer 16 can also be made of synthetic resin.

Each end surface of the pinion gear 14 and each end surface of the needle roller 15 are adjacent to the surface of the washer 16 on which the DLC coating is formed. The surface of the carrier 11 is adjacent to the surface of the washer 16 on the side opposite to the side adjacent to the pinion gear 14 and the needle roller 15.

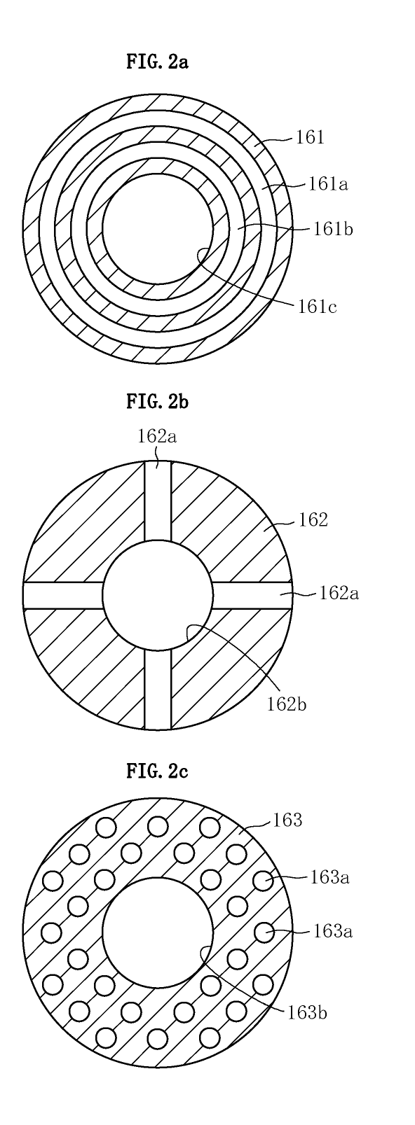

FIG. 2a to FIG. 2c are schematic diagrams of an example of recesses formed on the surface of the washer 16. In FIG. 2a to FIG. 2c, projections on the washer 16 are shaded to facilitate understanding.

FIG. 2a is an example of a washer 161 on the surface of which two circular grooves 161a and 161b are concentrically formed as the recesses. The circular grooves 161a and 161b are circles that are concentric with an outer edge and a through hole 161c of the washer 161. The through hole 161c through which the pinion shaft 13 is inserted is provided in the center of the washer 161. Lubricating oil is held within the concentric circular grooves 161a and 161b. Therefore, the lubricating oil can be spread in the circumferential direction over the end surface of the pinion gear 14 and the surface of the carrier 11. The lubricating oil can be held within the circular grooves 161a and 161b extending in the circumferential direction, even when centrifugal force accompanying the rotation of the washer 161 around the pinion shaft 13 and the rotation of the carrier 11 is applied.

FIG. 2b is an example of a washer 162 on the surface of which four linear grooves 162a, 162a, . . . are formed as the recesses. The linear grooves 162a, 162a, . . . are formed into straight lines extending in an outward radial direction from an outer edge of a through hole 162b formed in the washer 162. The through hole 162b through which the pinion shaft 13 is inserted is provided in the center of the washer 162. The lubricating oil can be supplied from the pinion shaft 13 side (through hole 162b side) to the outer peripheral side of the pinion gear 14 via the linear grooves 162a extending in the radial direction, as a result of centrifugal force accompanying movements of the pinion gear 14 and the carrier 11. The linear grooves 162a, 162a, . . . are not limited to four. Two linear grooves, three linear grooves, and the like can be formed evenly spaced in the circumferential direction.

FIG. 2c is an example of a washer 163 on the surface of which a plurality of circular bottomed holes 163a, 163a, . . . are formed as the recesses. The circular bottomed holes 163a, 163a, . . . are discretely formed over the surface of the washer 163. A through hole 163b through which the pinion shaft 13 is inserted is provided in the center of the washer 163. The lubricating oil is held evenly over the surface of the washer 163 by the bottomed holes 163a. Therefore, problems causing wear and seizing can be stably prevented on the contact surfaces of the pinion gear 14, the carrier 11, and the washers 163. The shape of the discretely formed bottomed holes is not limited to a circle.

The lubricating oil is supplied to the sliding portions of the pinion shaft 13, the pinion gears 14, and the carriers 11 in which the washer 16, such as those described above, is provided. For example, automatic transmission fluid (ATF) can be used as the lubricating oil. The lubricating oil can be supplied via an oil path formed within the pinion shaft 13.

Each gear in the planetary gear device 1 of the embodiment is constantly meshed with each other. As a result of driving force being applied to any element among three elements that are the sun gear, the carriers 11 and 11, and the outer gear, and any of the three elements being locked, driving force that is decelerated to a predetermined speed reduction ratio is outputted from the remaining element. As a result of assignment of the roles of being fixed, receiving the driving force, and outputting the driving force being changed among the three elements, switching can be performed between a plurality of speed reduction ratios and rotation directions.

When the planetary gear device 1 is operating, in accompaniment with the rotation of the pinion gear 14, the end surfaces of the pinion gear 14 and the surfaces of the washers 16, and the surfaces of the carriers 11 and 11 and the surfaces of the washers 16 come into sliding contact. In addition, the end surfaces of the needle roller 15 supporting the pinion gear 14 and the surfaces of the washers 16 come into sliding contact. When thrust load is applied to the pinion gear 14, the surface pressure applied to the washer 16 increases. Here, the DLC coating is formed on the surface of the washer 16. Therefore, wear and seizing that accompany sliding contact can be effectively prevented, even when two washers used in conventional planetary gear devices are not used. As a result, the number of components in the planetary gear device 1 can be reduced and complicated assembly can be reduced.

In addition, because the end surfaces of the needle roller 15 that comes into contact with the washers 16 are formed into spherical surfaces, seizing can be effectively prevented. As a result of the end surfaces of the needle roller 15 being formed into spherical surfaces, the surface pressure at the contact surfaces between the needle roller 15 and the washers 16 is large. However, the surface of the washer 16 has a higher hardness as a result of the DLC coating. Therefore, wear can be effectively prevented.

An embodiment of the present invention is described above. However, the present invention is not limited to the embodiment. Various modifications can be made. For example, although the DLC coating is used as the hard coating on the washer 16 according to the embodiment, the hard coating can be formed by chrome nitride (CrN).

In addition, the hard coating can be configured by an intermediate layer being interposed between the main component and the outermost layer composed of the DLC coating.

Although the pinion gear 14 is supported such as to rotate freely by the needle roller 15 that is in a full-complement state, the pinion gear 14 can be supported through use of another type of bearing device. For example, both end surfaces of the needle roller can be flat. A needle roller with a cage can also be used. An inner member can be fixed to the pinion shaft 13, while an outer member is fixed to the pinion gear 14. A rolling member can be interposed between the inner member and the outer member, allowing the pinion gear 14 to be supported to rotate freely. In this instance, the hard coating is formed on the surface of the washer 16 adjacent to the end surface of the outer member.

1-14. (canceled)

15. A planetary gear device in which a pinion gear is supported such as to rotate freely by a pinion shaft with a needle roller disposed on an outer circumferential surface of the pinion shaft therebetween, the pinion shaft being fixed to a carrier, wherein:
the carrier has a hard coating on a surface on the pinion gear side, and
the carrier and the pinion gear are adjacent to each other without a component interposed therebetween, and an end surface of the needle roller faces the hard coating on the carrier.

16. The planetary gear device according to claim 15, wherein the hard coating is composed of a diamond-like carbon coating having a hydrogen content of 10.0 atomic percent or less.

17. The planetary gear device according to claim 16, wherein the diamond-like carbon coating includes an amorphous carbon material.

18. The planetary gear device according to claim 16, wherein a thickness of the diamond-like carbon coating is 0.1 micrometer to 1 micrometer.

19. The planetary gear device according to claim 15, wherein the hard coating has a hardness of Hv1000 or more.

20. The planetary gear device according to claim 15, wherein the hard coating includes chrome nitride.

21. The planetary gear device according to claim 15, wherein a washer is interposed between the pinion gear and the carrier, a surface of the washer has a hard coating, and the washer is a single washer disposed between an end surface of the pinion gear and a surface of the carrier.

22. The planetary gear device according to claim 21, wherein the surface of the washer has a recess.

23. The planetary gear device according to claim 22, wherein the recess in the washer is a plurality of circular grooves concentric with a center of the washer.

24. The planetary gear device according to claim 22, wherein the recess in the washer is a plurality of linear grooves extending in a radial direction of the washer.

25. The planetary gear device according to claim 22, wherein the recess in the washer is a plurality of bottomed holes discretely provided on the surface of the washer.

26. The planetary gear device according to claim 21, wherein the pinion gear is held such as to rotate freely via the needle roller disposed on an outer circumferential surface of the pinion shaft, and end surfaces of the pinion gear and the needle roller face the surface of the washer.

27. The planetary gear device according to claim 21, wherein the hard coating has a hardness of Hv1000 or more.

28. The planetary gear device according to claim 21, wherein the hard coating includes a diamond-like carbon.

29. The planetary gear device according to claim 21, wherein the hard coating includes chrome nitride.

30. The planetary gear device according to claim 17, wherein a thickness of the diamond-like carbon coating is 0.1 micrometer to 1 micrometer.

31. The planetary gear device according to claim 16, wherein the hard coating has a hardness of Hv1000 or more.

32. The planetary gear device according to claim 17, wherein the hard coating has a hardness of Hv1000 or more.

33. The planetary gear device according to claim 18, wherein the hard coating has a hardness of Hv1000 or more.

34. The planetary gear device according to claim 30, wherein the hard coating has a hardness of Hv1000 or more.
